(19) United States
(12) Patent Application Publication
(10) Pub. No.: US 2007/0193953 A1
(43) Pub. Date: Aug. 23, 2007

(54) Method for aerating membrane modules

(76) Inventors: Stefan Schafer, Aachen (DE); Klaus Vossenkaul, Aachen (DE); Christoph Kullmann, Eschweiler (DE)

Correspondence Address: WILLIAM COLLARD;COLLARD & ROE, P.C., 1077 NORTHERN BOULEVARD, ROSLYN, NY, 11576, US

(21) Appl. No.: 10/594,880

(22) PCT Filed: Jan. 27, 2005
(86) PCT No.: PCT/EP05/00761

§ 371 Date: Oct. 30, 2006

(30) Foreign Application Priority Data
Apr. 2, 2004 (DE) 10 2004 017 012.6
Oct. 1, 2004 (DE) 10 2004 048 416.3

(51) Int. Cl. C02F 1/44

(52) U.S. Cl. 210/634

(57) ABSTRACT

The invention relates to a method for aerating a number of membrane modules of a membrane filtering installation operating in a submerged area. Air or a gas is supplied from a common source to the membrane modules and rises in the form of bubbles in the liquid to be purified. On-off valves are placed in the supply lines leading to the membrane modules whereby enabling or preventing the supply of air to an assigned membrane module. In a first method step, when all other membrane modules are closed, the on-off valve assigned to a first membrane module is additionally opened. At the beginning of a second method step, the on-off valve assigned to a second membrane module is opened whereby causing the formation of two partial air flows. At the beginning of a third method step, all membrane modules are aerated in succession until the aeration cycle in the first membrane module starts again.

The invention relates to a method for aerating multiple membrane modules of a membrane filter system operating in submerged operation,
whereby air or a gas is supplied to the membrane modules from a common source, which air or gas rises in the liquid to be purified, in the form of bubbles, on the outside of the membrane, and
whereby control valves are disposed in the feed lines to the membrane modules, which valves are activated according to a predetermined circuit schematic, and release or block the supply of air to an assigned membrane module.

The membrane modules are submerged into a basin with a liquid to be purified, e.g. a settling tank. The term “membrane module” within the scope of this invention also includes multiple membrane filters that form an aeration unit in the circuit schematic, and to which air or a gas is always supplied in common manner.

A method having the characteristics described initially is known from the reference US 2003/0 127 389 A1. In the case of the known method, the control valves are activated, one after the other, in such a manner that a great aeration air stream is supplied to one membrane module, in each instance, and all the other membrane modules are impacted with a permanent air stream that is smaller than 50% of the aeration air stream. In the case of stepless switching to a great aeration air stream, the membranes are subjected to great stress, particularly in the clamping region.

The invention is based on the task of indicating a simple method for aerating membrane modules, which is gentle on the membranes.

Proceeding from the method described initially, this task is accomplished, according to the invention, in that
in a first method step, the control valve assigned to a first membrane module is open, while the control valves of all the other membrane modules are closed, so that aeration of the first membrane module takes place,
that at the beginning of a second method step, the control valve assigned to a second membrane module is additionally opened, so that two partial air streams occur, with which the first and the second membrane module are impacted,
that at the beginning of a third method step, the control valve assigned to the first membrane module is closed, for aeration of the second membrane module, and
that all of the membrane modules are aerated in accordance with the method steps 1 to 3, one after the other, until the aeration cycle starts anew with the first membrane module.

Since the flow pressure loss decreases with the number of flow paths that are open at the same time, partial air streams that are greater than half the air stream that occurs during aeration of a single membrane module, in the first and third step, occur when two control valves are open. Because two control valves are opened at the same time during the second method step, a uniform start-up and shut-down procedure is achieved, in simple manner, during aeration of the corresponding membrane module.

Preferably, simple on/off control valves are used to implement the method, which valves can only assume the open or closed position. To avoid penetration of liquid into air-carrying parts of the membrane modules, it is practical if a blocking air volume stream flows through all of the feed lines, even when the control valves are in the closed position, which stream is small in comparison with the aeration air stream that exits when the control valve is open. The blocking air volume stream can be guaranteed by means of a bypass, for example in the form of an additional opening in the feed line. Alternatively to this, it is also possible, however, to configure the control valve in such a manner that even in the closed position of the control valve, a small free flow cross-section remains, through which the blocking air volume stream flows. It is practical if the blocking air volume stream amounts to less than 5% of that of the volume stream that exits from the corresponding feed line when the control valve in question is the only one in the open position.

The aeration cycle preferably amounts to more than 60 s. An aeration cycle of more than 120 s is particularly advantageous. With an increasing length of the aeration cycle, the air amount stream that must be made available by the blower becomes smaller. In the case of a longer aeration cycle, a blower with lower output can be used. From the aspect of energy-saving operation, the longest possible aeration cycles are therefore aimed at. For this reason, aeration cycles of 180 s and more should also be taken into consideration.

The length of the aeration cycle is dependent on a number of factors, for example on the tendency of the membrane modules to become contaminated, and on the effectiveness of the aeration device provided on or within the membrane modules. In order to maintain a high filtration output, every membrane module must be impacted with the maximal aeration air stream that is made available by the gas source, at certain time intervals. This time period can be influenced by the configuration of the aeration method. The configurations of the aeration method explained below allow stretching of the aeration cycles, in terms of time, and are advantageous from the aspect of energy-saving operation.

An advantageous embodiment of the method according to the invention provides that within the aeration cycle, all of the membrane modules are aerated with partial air streams, at the same time, once or multiple times, which partial air streams result from opening of all of the control valves. Alternatively, different groups of at least three membrane modules can be impacted with the total air stream, within the aeration cycle, one group after the other, whereby the air stream distributes itself approximately uniformly over the membrane modules that belong to the group, by means of opening the control valves, and whereby the control valves on all the other membrane modules are closed.

It furthermore lies within the scope of the invention that all of the membrane modules are aerated simultaneously, by means of opening the assigned control valves, between the aeration cycles. One embodiment variant provides that a group of at least three membrane modules is impacted with the air stream, in each instance, between the aeration cycles, whereby a first group of membrane modules is selected between the first and the second aeration cycle, a second group of membrane modules is selected between the second and the third aeration cycle, etc.

In the case of each of the embodiments described above, it is practical if the time during which all of the membrane modules are or a group of at least three membrane modules is aerated at the same time is at least just as long as the time interval during which the membrane modules are individually aerated during the aeration cycle.

In the following, the invention will be explained in detail using a drawing that shows an embodiment merely as an example. The figures schematically show:

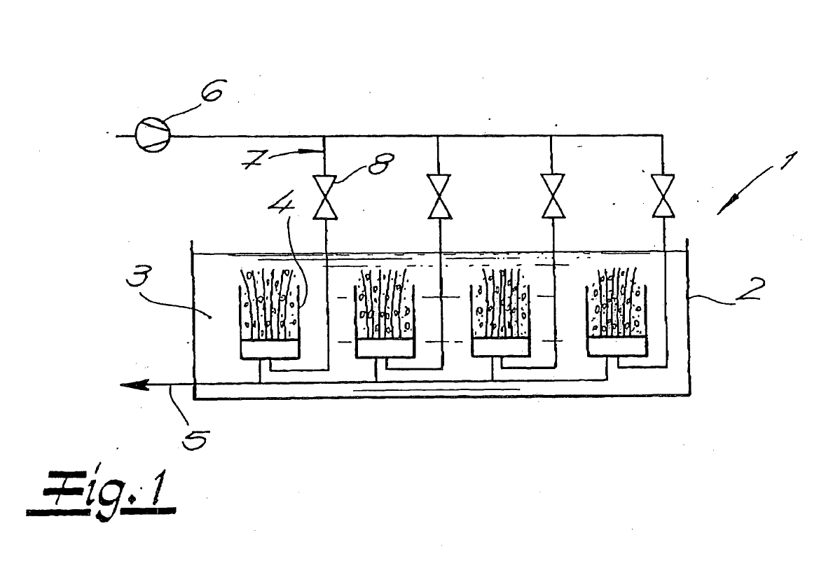

FIG. 1 a membrane filter system that can be operated with a method for aerating membrane modules, according to the invention,

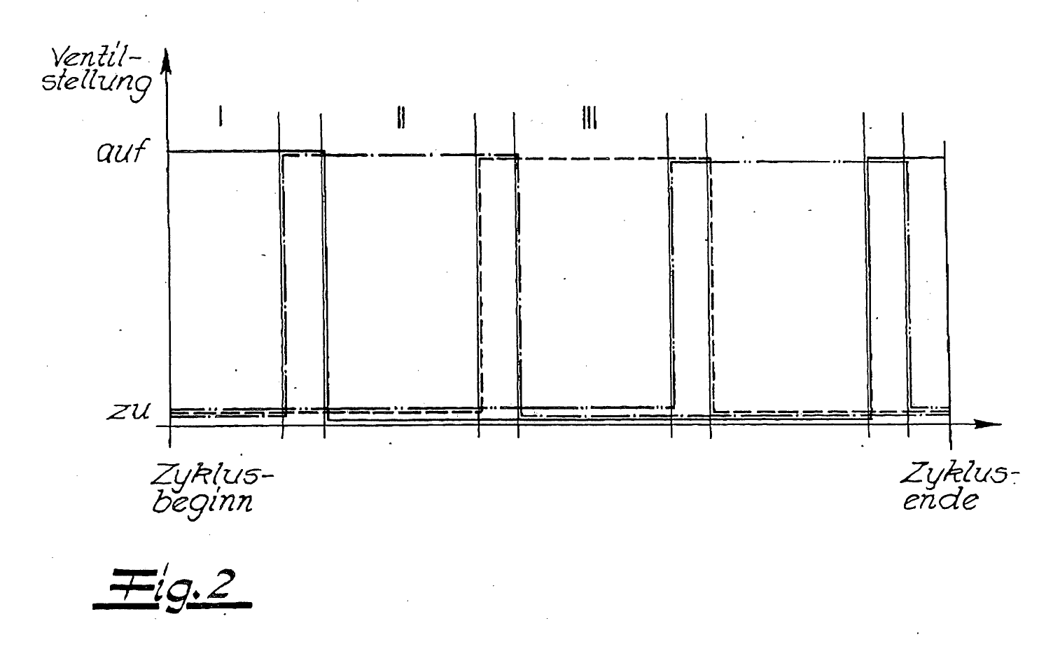

FIG. 2 a circuit schematic of a method according to the invention,

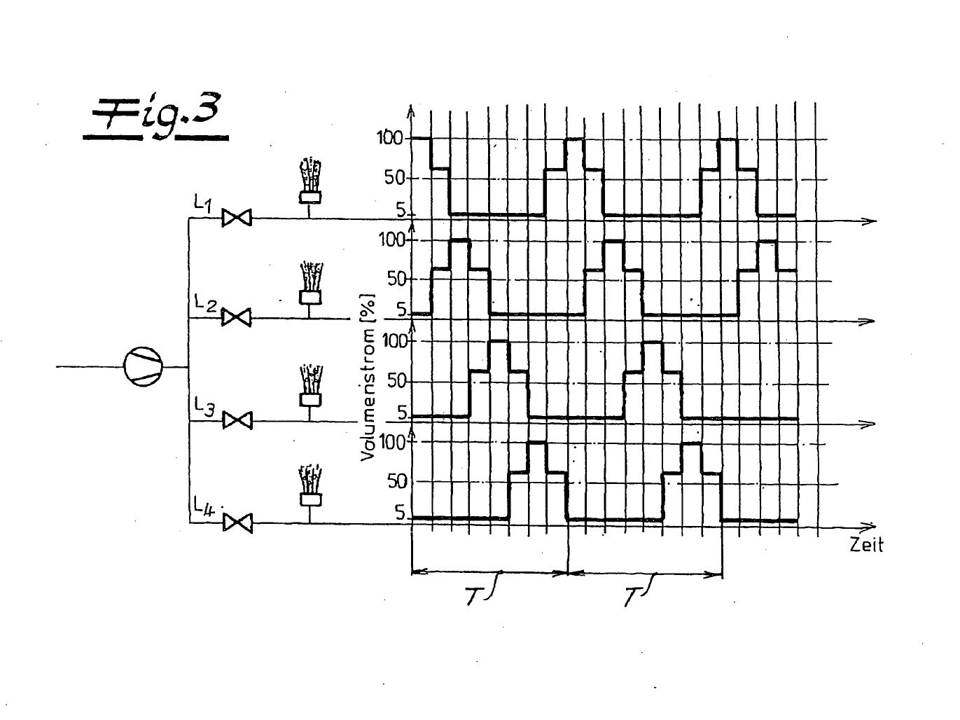

FIG. 3 the air volume streams that occur for aeration of the membrane modules,

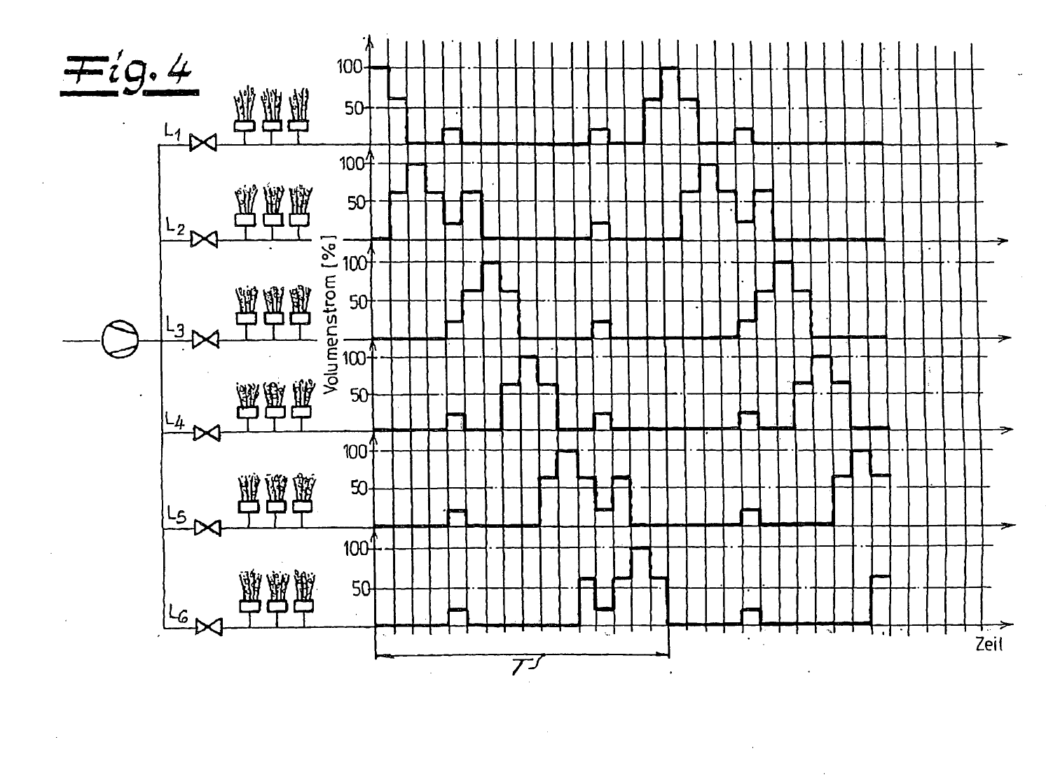

FIG. 4 to 7 embodiment variants of the method according to the invention.

FIG. 1 shows a membrane filter system 1, which has multiple membrane modules 4 submerged into a basin 2 containing a liquid 3 to be purified. The membrane modules are only shown schematically. The term “membrane module” is also supposed to cover a group of multiple filter units that are switched as an aeration unit, and therefore air is always applied to them at the same time. Hollow fiber membranes are used as membranes; they are combined in bundles and are fixed in a head piece with resin, with one end open on the permeate side. At their other end, the hollow fiber membranes are closed off individually. The membrane modules 4 are connected with a common permeate collection line 5. Air or a gas is supplied to them by way of a blower 6 or another gas source, from a common source, which air or gas rises in the liquid 3 to be purified, in the form of bubbles, on the outside of the membrane. Control valves 8 are disposed on the feed lines 7 to the membrane modules 4, which valves are activated according to a predetermined circuit schematic and release or block the air supply to an assigned membrane module 4. In a first method step I, the control valve 8 assigned to a first membrane module 4 is open during aeration of the membrane modules 4, while the control valves 8 of all the other membrane modules 4 are closed, so that aeration of the first membrane module 4 takes place with an air volume stream defined as 100% (see FIGS. 2 and 3). At the beginning of a second method step II, the control valve 8 assigned to a second membrane module 4 is additionally opened, so that two essentially stationary partial air streams occur, with which the first and the second membrane module 4 are impacted. The partial air streams are greater, in each instance, than 50% of the air volume stream that occurs in the first method step, when only one membrane module is aerated, since the flow pressure loss decreases with an increasing number of open lines. At the beginning of a third method step III for aeration of the second membrane module 4 at 100%, the control valve 8 assigned to the first membrane module 4 is closed. All of the membrane modules 4 are aerated in accordance with the method steps I to III, one after the other, until the aeration cycle T has been completed and aeration starts anew at the first membrane module 4. In the exemplary embodiment, the control valves 8 are configured as on/off fittings, which can assume only either the open or the closed position (see FIG. 2). It can be seen in FIG. 3 that in order to avoid penetration of liquid 3, a blocking air volume stream flows through all of the feed lines 7 even when the control valves 8 are in the closed position. The blocking air volume stream can exit by means of an additional opening in the corresponding feed line 7, for example. In the exemplary embodiment, the control valves 8 are configured in such a manner that they have a remaining free flow cross-section even in the closed position, through which the blocking air volume stream flows. FIG. 3 furthermore shows that the blocking air volume stream amounts to less than 5% of the air volume stream that exits from the corresponding feed line when the control valve 8 in question is the only one in the open position. Entry of liquid 3 into the submerged feed lines 7 is prevented by means of the blocking air volume stream.

FIG. 4 shows another embodiment of the method according to the invention. All of the membrane modules 4 are aerated with partial air streams L₁, L₂, . . . Lᵢ, multiple times, within the aeration cycle T, which partial air streams occur from opening all the control valves 8.

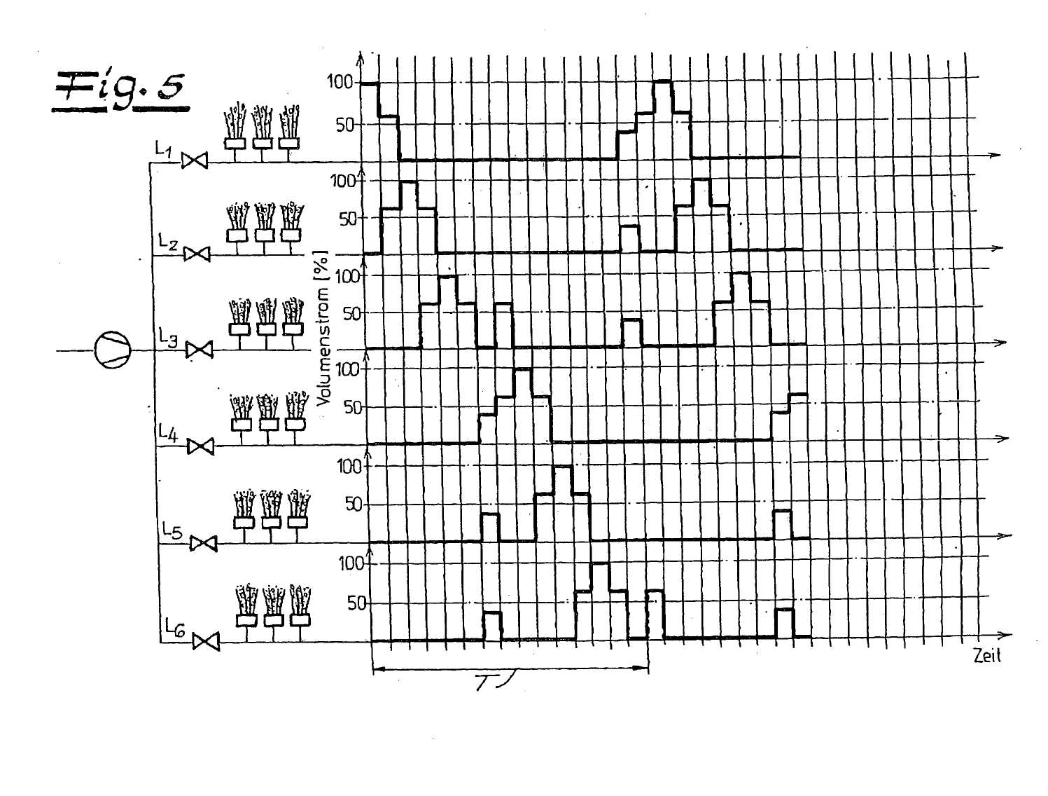

In the case of the embodiment variant shown in FIG. 5, different groups of at least three membrane modules are impacted with the total air volume stream within the aeration cycle T, one group after the other, whereby the air stream distributes itself approximately uniformly over the membrane modules that belong to the group, and whereby the control valves on all the other membrane modules are closed.

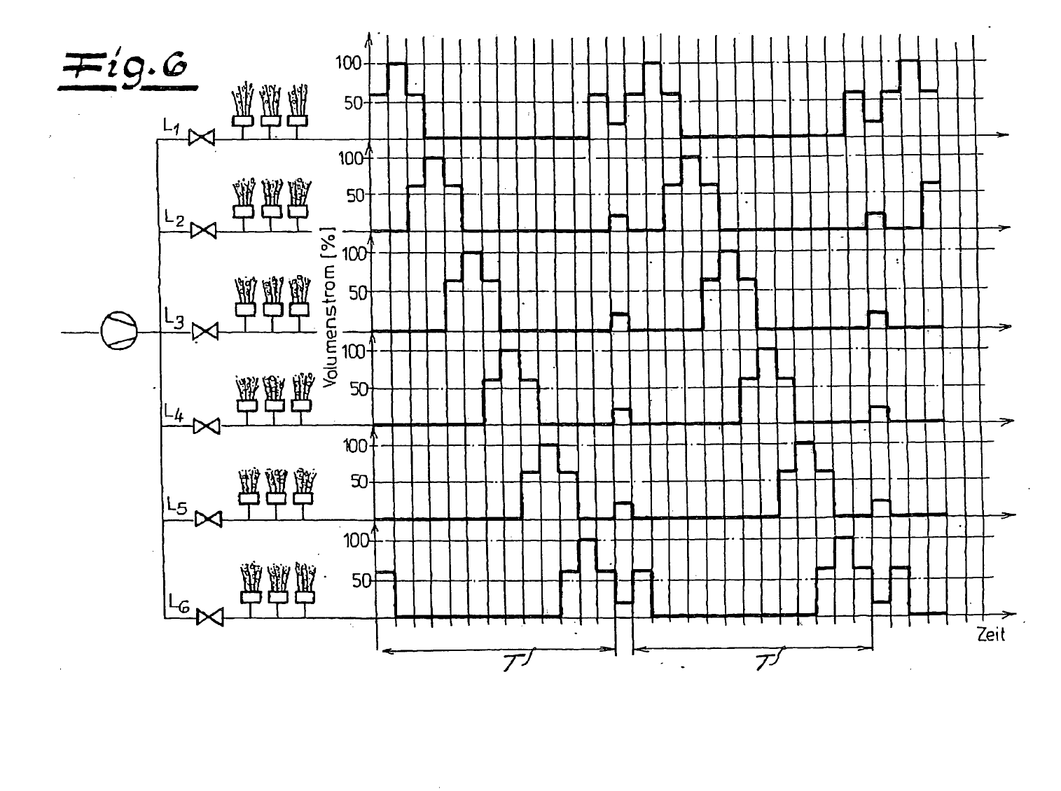

FIG. 6 shows an embodiment of the method according to the invention in which all of the membrane modules 4 are aerated at the same time, between the aeration cycles T, by opening the assigned control valves 8.

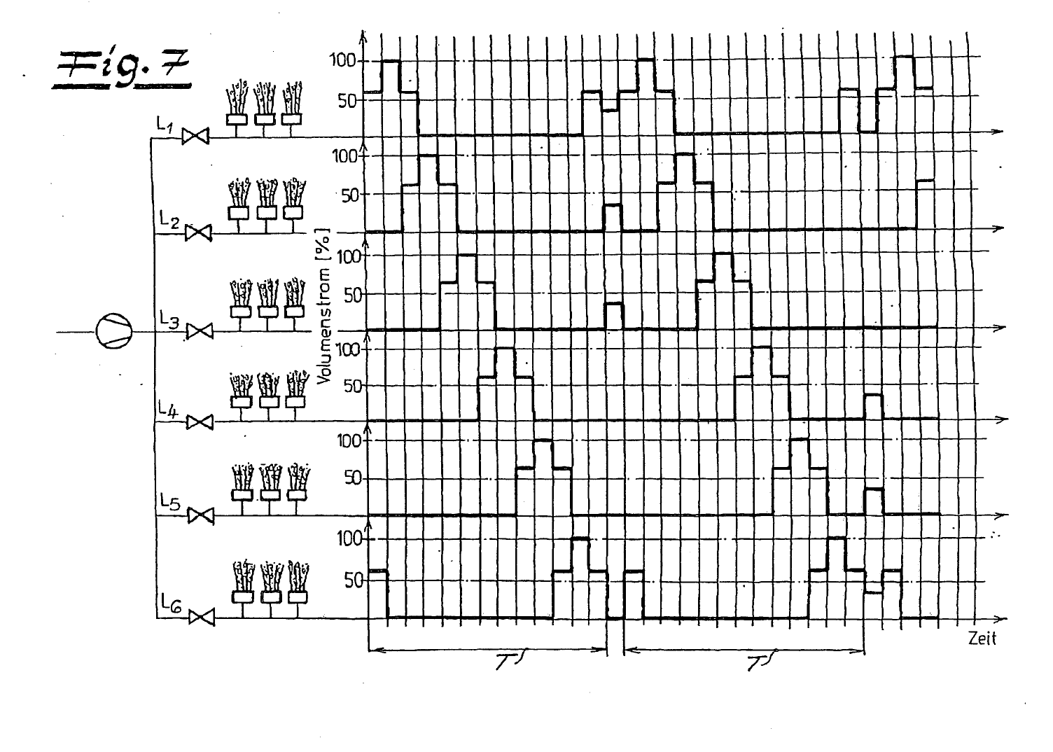

In the case of the embodiment of the method according to the invention shown in FIG. 7, a group of at least three membrane modules is impacted with the air stream, in each instance, between the aeration cycles, whereby a first group of membrane modules is selected between the first and the second aeration cycle, a second group of membrane modules is selected between the second and the third aeration cycle, and so forth.

The time during which all the membrane modules are or a group of at least three membrane modules is aerated at the same time is just as long, in the exemplary embodiments, as the time interval during which the membrane modules are aerated individually during the aeration cycle. Deviations both downward and upward are possible. In the case of all of the exemplary embodiments described above, an aeration cycle T of more than 60 s can be set, and it preferably amounts to more than 120 s. However, aeration cycles of less than 60 s are not supposed to be precluded.

1-10. (canceled)

11. Method for aerating multiple membrane modules of a membrane filter system operating in submerged operation,
whereby air or a gas is supplied to the membrane modules from a common source, which air or gas rises in the liquid to be purified, in the form of bubbles, on the outside of the membrane, and
whereby valves are disposed in the feed lines to the membrane modules, which valves are activated according to a predetermined circuit schematic,
whereby control valves are used as valves, which can assume only either the open or closed position, and thus release or block the supply of air to an assigned membrane module,
that in a first method step, the control valve assigned to a first membrane module is open, while the control valves of all the other membrane modules are closed, so that aeration of the first membrane module takes place,
that at the beginning of a second method step, the control valve assigned to a second membrane module is additionally opened, so that during this method step, two control valves are open at the same time and two essentially stationary partial air streams occur, with which the first and the second membrane module are impacted,
that at the beginning of a third method step, the control valve assigned to the first membrane module is closed, for aeration of the second membrane module, and
that all of the membrane modules are aerated in accordance with the three method steps, one after the other, until the aeration cycle starts anew with the first membrane module.

12. Method according to claim 11, wherein to avoid penetration of liquid into air-carrying parts of the membrane modules, a blocking air volume stream flows through all of the feed lines, even when the control valves are in the closed position, which stream is small in comparison with the aeration air stream that exits when the control valve is open.

13. Method according to claim 12, wherein the blocking air volume stream amounts to less than 5% of that of the volume stream that exits from the corresponding feed line when the control valve in question is the only one in the open position.

14. Method according to claim 11, wherein the aeration cycle amounts to more than 60 s, preferably more than 120 s.

15. Method according to claim 11, wherein within the aeration cycle, all of the membrane modules are aerated with partial air streams, at the same time, once or multiple times, which partial air streams result from opening of all of the control valves.

16. Method according to claim 11, wherein different groups of at least three membrane modules are impacted with the total air stream, within the aeration cycle, one group after the other, whereby the air stream distributes itself approximately uniformly over the membrane modules that belong to the group, by means of opening the control valves, and whereby the control valves on all the other membrane modules are closed.

17. Method according to claim 11, wherein of the membrane modules are aerated simultaneously, by means of opening the assigned control valves, between the aeration cycles.

18. Method according to claim 11, wherein a group of at least three membrane modules is impacted with the air stream, in each instance, between the aeration cycles, whereby a first group of membrane modules is selected between the first and the second aeration cycle, a second group of membrane modules is selected between the second and the third aeration cycle, etc.

19. Method according to claim 18, wherein the time during which all of the membrane modules are or a group of at least three membrane modules is aerated at the same time is at least just as long as the time interval during which the membrane modules are individually aerated during the aeration cycle.
